(19) United States
(12) Patent Application Publication
(10) Pub. No.: US 2024/0349377 A1
(43) Pub. Date: Oct. 17, 2024

(54) COMMUNICATING ON A FIRST CHANNEL AND A SECOND CHANNEL

(71) Applicant: Telefonaktiebolaget LM Ericsson (publ), Stockholm (SE)

(72) Inventors: Abhishek AMBEDE, Huddinge (SE); Rocco DI TARANTO, Lund (SE); Sebastian MAX, Cologne (DE); Charlie PETTERSSON, Solna (SE); Jonas SEDIN, Brentford (GB); Dennis SUNDMAN, Sollentuna (SE); Leif WILHELMSSON, Lund (SE)

(21) Appl. No.: 18/689,699

(22) PCT Filed: Sep. 10, 2021
(86) PCT No.: PCT/EP2021/074997

§ 371 Date: Mar. 6, 2024

(51) Int. Cl. H04W 76/15; H04W 28/08

(52) U.S. Cl. CPC H04W 76/15; H04W 28/0967

(57) ABSTRACT

Methods and apparatus are provided. In an example aspect, a method in a first wireless communication device of communicating with at least one second wireless communication device on a first channel and a second channel is provided. The method includes selecting a simultaneous transmit and receive (STR) communication mode or non-simultaneous transmit and receive (NSTR) communication mode for communicating with the at least one second wireless communication device on the first channel and the second channel, selecting supported communication parameters for at least one of the first channel and the second channel based on the selected mode, and communicating with the at least one second wireless communication device on the first channel and the second channel using the selected communication mode and according to the selected supported communication parameters.

### TECHNICAL FIELD

Examples of the present disclosure relate to communicating on a first channel and a second channel, for example in a Multi-Link Device (MLD).

### BACKGROUND

Wireless networks based on the IEEE 802.11 wireless local area network (WLAN) standard have dominated the deployments in licence-exempt spectrum (unlicensed spectrum) worldwide. Due to the recent availability of licence-exempt spectrum in the 6 GHz frequency band, there is an ever-increasing interest in low and bounded latency WLANs to support, for example, applications in Industrial Internet of Things (IIoT) scenarios, gaming, and other scenarios. To support these applications, one requirement is that a packet is always transmitted “at the right time”, i.e., a transmitter should preferably be able to access the wireless channel with a delay (latency) whose variation around the mean (jitter) is guaranteed to be bounded. However, the IEEE 802.11 WLAN standard has so far not been developed with an emphasis on achieving low or bounded latency wireless communications. Moreover, the nature of the channel access rules and the regulations for license-exempt spectrum do not make it possible for a WLAN to provide deterministic channel access opportunities for the transmitting stations (STAs), unless the WLAN devices operate in contention free orthogonal frequency division multiple access (OFDMA) scheduled mode and in a completely controlled environment (i.e. in absence of any interference), thereby causing inability to guarantee end-to-end bounded latency or delays. It is thus very challenging for WLANs to support applications that require low and bounded latency in licence-exempt spectrum.

An amendment to the IEEE 802.11 WLAN standard, which is currently under development by the IEEE 802.11 Task Group be (TGbe), is IEEE 802.11be, also termed as Extremely High Throughput or EHT. EHT introduces a new key feature called multi-link (ML). In ML, a device termed as multi-link device (MLD) has multiple affiliated STAs, each of which can communicate using independent wireless channels (links). An access point (AP) MLD is defined as a MLD with two or more affiliated AP STAs, and a non-AP MLD is a MLD with two or more affiliated non-AP STAs. Communication over multiple channels (links) by a MLD is termed as multi-link operation (MLO). For example, a MLD can have two affiliated STAs—one communicating using a channel in the 2.4 GHz frequency band and the other communicating using a channel in the 5 GHz frequency band. As another example, a MLD can have two affiliated STAs—each communicating using one of two different channels in the 6 GHz frequency band.

A MLD can use its affiliated STAs and corresponding supported channels to perform simultaneous transmit (TX) MLO, simultaneous receive (RX) MLO, or simultaneous TX and RX (STR) MLO. ML in EHT can thus help to improve the throughput as well as latency performance of WLANs. However, a MLD trying to perform STR MLO may face severe cross-channel self-interference (SI) problems due to leakage from its TX to RX channels. The cross-channel SI signal power in a RX channel from a TX channel can be orders of magnitude higher than the power of the desired signal, thereby affecting the reception/sensing ability of the RX chain. If a MLD can perform STR over a supported link pair without suffering from or by tackling the cross-channel SI problem, that link pair is classified as STR. However, if transmitting over one link results in inability to simultaneously receive over another link, that link pair is classified as non-STR (NSTR). Also, for a pair of STAs, STA1 and STA2, affiliated with a MLD, the cross-channel SI caused to STA2's reception due to STA1's transmission may or may not be equivalent to the cross-channel SI caused to STA1's reception due to STA2's transmission. Despite this non-reciprocal behavior, if the link pair is NSTR due to at least one of the corresponding STA's transmissions, the EHT draft standard requires that this link pair must be classified as NSTR by the MLD. A MLD shall announce its STR or NSTR capability related to all supported link pairs.

Simultaneous TX MLO and simultaneous RX MLO over a NSTR link pair require that the transmissions over the two links are synchronized to some extent, and this may put strict requirements while executing such MLOs. Usage of a STR link pair, on the other hand, will not impose such requirements. In the case of a STR link pair, channel access on one link can be done independently and regardless of any activity occurring on the other link. However, in case of NSTR link pairs, numerous rules and restrictions may be necessary to prevent the occurrence of STR (that would cause severe cross-channel SI). These may make it difficult to perform MLOs using NSTR link pairs in practice, and this is further compounded by the random nature of channel access in licence-exempt (unlicensed) spectrum. Thus, it may not be very feasible for a NSTR MLD to perform MLOs and be able to take maximum advantage of the various benefits offered by the ML feature in EHT, such as improvements in latency due to independent channel access on multiple links. Some examples of such rules and restrictions, as defined for example by the current IEEE 802.11be draft standard, are described below.

Rules to prevent NSTR non-AP MLD from transmitting while receiving may be defined. In the case of a NSTR link pair at a non-AP MLD, a STA that is affiliated with that MLD should not transmit while reception at another STA within the same MLD is ongoing and vice-versa, and an AP MLD should not transmit to a STA within that MLD while the same MLD is transmitting on another channel. It is up to the AP MLD to ensure that the STAs affiliated with a NSTR non-AP MLD do not transmit and receive physical layer protocol data units (PPDUs) simultaneously.

A set of transmission rules known as ‘PPDU end-time alignment’ may be defined, whereby an AP MLD makes sure that transmission of PPDUs across a NSTR link pair at a non-AP MLD ends at approximately the same time, so as to make sure that all of the Block Acknowledgements (BAs) that will be transmitted in response to the PPDUs are transmitted at the same time, thereby ensuring that the NSTR non-AP MLD is not forced to transmit and receive at the same time.

Additionally, a set of transmission rules known as ‘Start time sync PPDUs medium access’ may be defined for a NSTR MLD (applicable for both an AP MLD as well as a non-AP MLD) that attempts synchronous transmissions of PPDUs over a NSTR link pair. Such a NSTR MLD contending for the wireless medium to become a transmit opportunity (TXOP) holder and that aligns the start times of the PPDUs scheduled for transmission on more than one link shall ensure that the Enhanced Distributed Channel Access (EDCA) count down procedure is completed in all the links. It is specified that a STA that is affiliated with a NSTR MLD shall follow the channel access procedure described below:
The STA may initiate transmission on a link when the medium is idle and one of the following conditions is met:
   The backoff counter of the STA reaches zero on a slot boundary of that link.
   The backoff counter of the STA is already zero, and the backoff counter of another STA of the affiliated MLD reaches zero on a slot boundary of the link that the other STA operates.

In addition to the strict rules and restrictions described above regarding performing MLOs using NSTR link pairs, further stringent rules and restrictions are being developed in TGbe specifically for NSTR Soft AP MLDs. A NSTR Soft AP MLD typically resides in a battery-powered mobile device. The following restrictions and resulting drawbacks may be defined for NSTR Soft AP MLDs.

For a NSTR Soft AP MLD serving single link non-AP STAs, rules may be defined such that only one AP of the affiliated APs operating in an NSTR link pair sends Beacon and Probe Response frames. This results in that any single link non-AP STAs can associate with the NSTR Soft AP MLD only over one link (which is designated as the primary link) out of the NSTR link pair. This rule is motivated by the limitation that the NSTR Soft AP MLD would not be able to independently operate over the two links due to them constituting a NSTR link pair. Thus, the non-primary link would be completely useless in this scenario and cannot be used for serving even one single link non-AP STA.

For a NSTR Soft AP MLD serving non-AP MLDs, rules may be defined such that a STA (or AP) affiliated with the non-AP MLD (or NSTR Soft AP MLD) may initiate a PPDU transmission to its associated NSTR Soft AP (or non-AP STA) in the non-primary link only if the STA (or AP) affiliated with the same MLD in the primary link is also initiating the PPDU as a TXOP holder with the same start time. This results in that non-AP MLDs and the NSTR Soft AP MLD cannot communicate with each other without involving the primary link. Moreover, the usage of the non-primary link is dependent on the activity over the primary link. This rule is motivated by the limitation that the NSTR Soft AP MLD would not be able to perform STR MLO over the two links. Thus, similar to the abovementioned scenario while serving single link non-AP STAs, the non-primary link would be under-utilized in this scenario.

Thus, a NSTR Soft AP MLD would not be able to take maximum advantage of the various benefits offered by its ML capabilities while serving its associated non-AP STAs. The capabilities and the quality of service (QOS) offered by a NSTR Soft AP MLD to its associated non-AP STAs would be severely restricted when compared to those offered by a STR AP MLD. For example, a STR AP MLD that spreads its associated single link non-AP STAs across multiple links would be able to ensure better latency performance (e.g. in terms of channel access possibilities, reduction of contention and/or reduction of collisions) when compared to a NSTR Soft AP MLD that would have to support all associated single link non-AP STAs only over a single link.

### SUMMARY

If applications and use cases supported in wired networks based on time-sensitive networking (TSN) standards, or other low or bounded latency applications, are to be supported over the wireless medium and possibly in licence-exempt spectrum, wireless networks should be able to fulfill strict performance requirements with respect to latency and reliability. Therefore, there is a need for features in wireless networks such as WLANs to support applications with requirements in terms of latency and reliability that may be as strict as those supported in wired networks, or wireless networks using licensed spectrum.

One aspect of the present disclosure provides a method in a first wireless communication device of communicating with at least one second wireless communication device on a first channel and a second channel. The method comprises selecting a simultaneous transmit and receive, STR, communication mode or non-simultaneous transmit and receive, NSTR, communication mode for communicating with the at least one second wireless communication device on the first channel and the second channel, and selecting supported communication parameters for at least one of the first channel and the second channel based on the selected mode. The method also comprises communicating with the at least one second wireless communication device on the first channel and the second channel using the selected communication mode and according to the selected supported communication parameters.

A further aspect of the present disclosure provides apparatus for communicating with at least one second wireless communication device on a first channel and a second channel. The apparatus comprises a processor and a memory. The memory contains instructions executable by the processor such that the apparatus is operable to select a simultaneous transmit and receive, STR, communication mode or non-simultaneous transmit and receive, NSTR, communication mode for communicating with the at least one second wireless communication device on the first channel and the second channel, select supported communication parameters for at least one of the first channel and the second channel based on the selected mode, and communicating with the at least one second wireless communication device on the first channel and the second channel using the selected communication mode and according to the selected supported communication parameters.

An additional aspect of the present disclosure provides apparatus for communicating with at least one second wireless communication device on a first channel and a second channel. The apparatus is configured to select a simultaneous transmit and receive, STR, communication mode or non-simultaneous transmit and receive, NSTR, communication mode for communicating with the at least one second wireless communication device on the first channel and the second channel, select supported communication parameters for at least one of the first channel and the second channel based on the selected mode, and communicating with the at least one second wireless communication device on the first channel and the second channel using the selected communication mode and according to the selected supported communication parameters.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a flow chart of an example of a method in a first wireless communication device of communicating with at least one second wireless communication device on a first channel and a second channel; and

FIG. 2 is a schematic of an example of an apparatus for communicating with at least one second wireless communication device on a first channel and a second channel.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Due to the random nature of channel access in licence-exempt spectrum and the stringent rules and restrictions related to usage of NSTR link pairs, it may not be practically feasible for a NSTR MLD to execute efficient MLOs and take maximum advantage of its ML capabilities. Thus, the operation of MLDs as STR MLDs may be desirable, especially when operating as an AP MLD. It may be straightforward for a MLD to achieve STR operation with sufficient channel separation while operating over channels from different frequency bands, for example, one channel in 2.4 GHz frequency band and another in 5 GHz frequency band. However, when a MLD operates over multiple channels in the same frequency band (for example, the 5 GHz frequency band), it may not be always possible to ensure sufficient channel separation for being STR-capable using those channels.

The draft 802. 11be standard referred to above only supports the rigid but practically simple STR or NSTR capability signaling and related MLOs by a MLD over a supported link pair. That is, for example, a link pair is either classed as supporting STR or not supporting STR (and hence being a NSTR link pair). However, the capability of a MLD corresponding to a link pair may not always be just binary, i.e., either STR or NSTR. The STR or NSTR capability can sometimes depend on multiple variable communication parameters such as TX power, RX power, modulation and coding scheme (MCS), signal bandwidths, number of spatial streams and so on. A MLD may be STR-capable over a link pair for some combinations of values of communication parameters and may not be STR-capable for some other combinations. For example, STR may be possible over a link pair as long as a transmitting STA does not exceed a certain power level such that a receiving STA in the same MLD is unable to successfully receive a signal over a different channel or link. (In this disclosure, the terms ‘channels’ and ‘links’ are used interchangeably.) Such a link pair can be termed in this disclosure as being STR-constrained. The following numerical example illustrates the possibility for a MLD to have STR-constrained behavior over a link pair.

Consider a MLD with two affiliated STAs, STA1 and STA2, operating over channels CH1 and CH2 respectively and both with 20 dBm maximum TX power. Let the thermal noise floor be at −95 dBm for both STA1 and STA2 during reception.
STR behavior: If the cross-channel SI power corresponding to CH1-CH2 link pair is such that its level at STA1 or STA2 when transmitting using STA2 or STA1 respectively even with maximum TX power (i.e., 20 dBm TX power) is sufficiently below the noise floor (i.e., <<−95 dBm), the MLD will always be STR over CH1-CH2. This corresponds to cross-channel SI suppression of >>115 dB.
STR-constrained behavior: If the cross-channel SI suppression is not sufficient and the resulting cross-channel SI power level at STA1 or STA2 is near or above the noise floor (i.e., is ≥−95 dBm), the MLD may be STR or NSTR depending upon the resultant signal-to-interference-plus-noise ratio (SINR) during the reception of a desired signal.
   Dependency on RX power and RX MCS: If the cross-channel SI power level at STA1 is −80 dBm (due to 20 dBm TX power of STA2 and cross-channel SI suppression=100 dB), the reception of the desired signal at STA1 would succeed or fail depending upon the RX power of the desired signal. If the RX power at STA1 is −90 dBm, then reception is likely to fail due to the resulting signal-to-interference ratio (SIR) being −10 dB. On the contrary, if the RX power at STA1 is −70 dBm, a resulting SIR of 10 dB may allow the reception of signals using a robust MCS (for example, MCS index 0 to 2).
   Dependency on TX power and RX MCS: Let the RX power of the desired signal at STA1 be −85 dBm. If the TX power of STA2 is 20 dBm, a cross-channel SI suppression of 100 dB would lead to resulting SIR=−5 dBm at STA1, thereby causing failed reception. However, if the TX power of STA2 is 5 dBm, a cross-channel SI suppression of 100 dB would lead to resulting SIR=10 dBm at STA1, thereby enabling the reception of signals using a robust MCS (for example, MCS index 0 to 2).

Such STR-constrained behavior may be observed for example when a MLD operates over multiple channels in the same frequency band (for example, the 5 GHz frequency band), where it may not be always possible to ensure sufficient channel separation to allow a link or channel pair to be (non-constrained) STR-capable.

There is a likelihood in prior solutions that a STR-constrained link pair would be simply classified as NSTR by a MLD. However, it would be inefficient to declare such a link pair as NSTR if it cannot be used for STR MLO for only a subset of combinations of the various communication parameters. There is therefore a need to allow MLDs to efficiently operate over STR-constrained link pairs and be able to take more advantage of their ML capabilities.

In embodiments of this disclosure, a first wireless communication device (e.g. a MLD) that may communicate with at least one second wireless communication device on a first channel and a second channel (e.g. using a link pair) may, for example, make a decision on whether to operate in a STR mode or NSTR mode. The first wireless communication device may then determine the set of its supported communication parameters for one or both the links in that link pair, for example based on the selected mode. Thus, for example, the set of communication parameters for operating in STR mode using the link pair may be an adapted or limited version of the set of communication parameters for operating in NSTR mode.

Embodiments proposed herein may for example enable a MLD to operate as a STR MLD using a link pair over which it is STR-constrained, rather than operating as a NSTR MLD which would mandate adherence to multiple NSTR-related rules including one or more of those discussed above. Compared to operating as a NSTR MLD, operating as a STR MLD provides numerous benefits, for example in terms of independent channel access possibilities, and this can in some examples lead to advantages in terms of latency performance for not just the MLD, but also for other devices e.g. in a WLAN.

For a MLD that may normally operate as a NSTR MLD over a STR-constrained link pair, embodiments of this disclosure may provide the possibility to instead operate as a STR MLD by determining an adapted set of supported communication parameters. In some examples, a wireless communication device such as a MLD may itself choose between the two operating modes (NSTR and STR), and this can be beneficial for the device, as it can then adapt its operation to best suit the underlying requirements of the communication scenario that is involved in (e.g. QoS requirements, data latency requirements, throughput etc). Embodiments of this disclosure can be especially beneficial for example when a MLD that normally operates as a NSTR non-AP MLD operates as an AP MLD, as this can allow the MLD to operate as a STR AP MLD instead of operating as a NSTR Soft AP MLD.

The first wireless communication device may announce the STR or NSTR communication mode. The first wireless communication device may also for example undertake appropriate signaling to announce the determined set of its supported communication parameters to its associated STAs. This would ensure that the first wireless communication device, which may be a MLD, and its associated STAs communicate using the determined set of communication parameters, thereby also ensuring that the MLD can operate in its chosen STR or NSTR communication mode.

The determined set of communication parameters may include, for example, one or more of maximum supported TX power, supported RX MCSs (e.g. number of supported MCSs, highest order supported MCS, highest supported data rate MCS), supported signal bandwidths (e.g. maximum and/or minimum supported signal bandwidths), and maximum number of supported spatial streams.

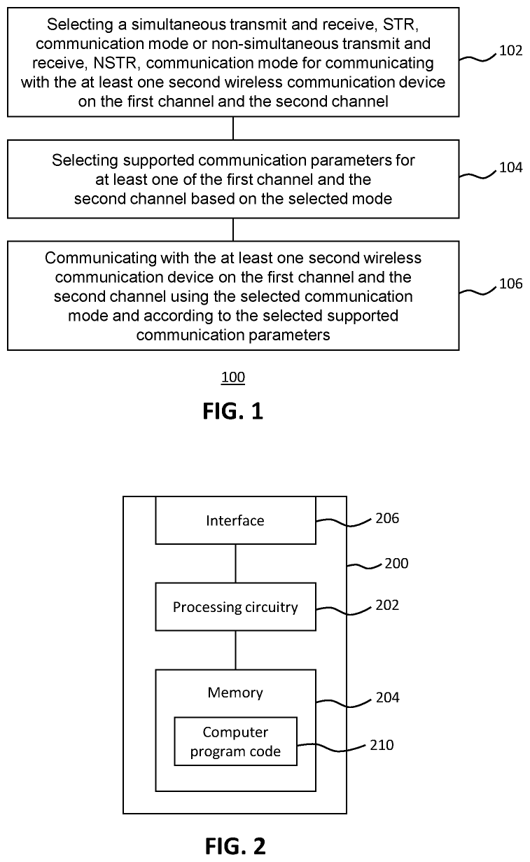

FIG. 1 is a flow chart of an example of a method 100 in a first wireless communication device of communicating with at least one second wireless communication device on a first channel and a second channel according to an embodiment of this disclosure. The first wireless communication device may comprise a multi-link device (MLD) in some examples, and thus may for example communicate on the first and second channels using respective stations (STAs) within or affiliated with the first wireless communication device. The first and second channels may be considered for example as a link pair.

The method 100 comprises, in step 102, selecting a simultaneous transmit and receive, STR, communication mode or non-simultaneous transmit and receive, NSTR, communication mode for communicating with the at least one second wireless communication device on the first channel and the second channel. Thus for example the first wireless communication device makes a decision as to the communication mode in which to communicate on the first and second channels. The decision may be made based on one or more of various factors, including for example one or more of attributes of data to be transmitted to and/or received from the at least one second wireless communication device. The attributes of the data may include for example one or more of a maximum latency requirement for the data, a Quality of Service, QoS, for the data, an amount of the data, and a throughput requirement for the data. In one example, the first wireless communication device may select the STR communication mode where there is latency sensitive data to be transmitted or received, e.g. the latency requirement for transmission of the data from the first wireless communication device to the at least one second wireless communication device (or vice versa) may be below a certain threshold. The use of STR mode in these circumstances may lead to reduced delays/latency for such transmitted data as explained above.

Step 104 of the method 100 comprises selecting supported communication parameters for at least one of the first channel and the second channel based on the selected mode. For example, the supported communication parameters may vary based on the selected mode. In one example, selecting supported communication parameters for at least one of the first channel and the second channel based on the selected mode in step 104 may comprise selecting first supported communication parameters if the selected mode is the STR mode and selecting second supported communication parameters if the selected mode is the NSTR mode, and wherein the first supported communication parameters and the second supported communication parameters are different. The supported communication parameters may have one or more of the following properties:
The first supported communication parameters may include a lower maximum transmission power for at least one of the first channel and the second channel than the second supported communication parameters. In other words, for example, for operating over a STR-constrained link pair, a MLD may determine to lower its maximum supported TX power for one or both affiliated STAs such that the resultant cross-channel SI power level would be sufficiently below the thermal noise floor, thereby allowing the MLD to operate as a STR MLD over that link pair.
The first supported communication parameters may include a lower of maximum data rate modulation and coding scheme, MCS, for at least one of the first channel and the second channel than the second supported communication parameters. A lower data rate MCS may for example be more robust against self-interference than a higher data rate MCS. This may also result in fewer MCSs being supported in the first supported communication parameters than in the second supported communication parameters. In other words, for example, for operating over a STR-constrained link pair, a MLD may determine to reduce the set of its supported RX MCSs for one or both affiliated STAs by accounting for the worst-case cross-channel SI, thereby allowing the MLD to operate as a STR MLD over that link pair.
The first supported communication parameters may include a lower maximum bandwidth for at least one of the first channel and the second channel than the second supported communication parameters. In other words, for example, for operating over a STR-constrained link pair, a MLD may determine to limit the set of its supported signal bandwidths for one or both affiliated STAs and support only those signal bandwidths that lead to acceptable levels of cross-channel SI, thereby allowing the MLD to operate as a STR MLD over that link pair. In some examples, a smaller bandwidth for one or both channels may increase the channel separation between the channels and thus more likely to support STR mode of communication.
The first supported communication parameters may include a lower maximum number of spatial streams for at least one of the first channel and the second channel than the second supported communication parameters. In other words, for example, for operating over a STR-constrained link pair, a MLD may determine to lower its maximum number of supported spatial streams for one or both affiliated STAs by accounting for the worst-case cross-channel SI, thereby allowing the MLD to operate as a STR MLD over that link pair.

Thus, for example, the supported communication parameters may ensure that a lower maximum level of self-interference (SI) is caused to a receiving STA by the transmitting STA within the first wireless communication device in STR mode compared to NSTR mode, or that the supported communication parameters may ensure a higher robustness against SI at the receiving STA in STR mode compared to NSTR mode.

In some examples, the first supported communication parameters may include a first subset of supported communication parameters for simultaneous transmission on the first channel and reception on the second channel by the first wireless communication device, and a second subset of supported communication parameters for simultaneous reception on the first channel and transmission on the second channel by the first wireless communication device, and wherein the first subset and the second subset are different. In other words, for example, the communication parameters may be different depending on which of the first channel and the second channel is used for transmission and which is used for reception. This may be for example as a result of particular hardware features or constraints of the first wireless communication device.

The method 100 also includes the step 106 of communicating with the at least one second wireless communication device on the first channel and the second channel using the selected communication mode and according to the selected supported communication parameters.

As indicated above, the first wireless communication device may in some examples comprise a first multi-link device (MLD). Thus, for example, the first MLD has affiliated with it a first station, STA, and a second STA. The at least one second wireless communication device may also comprise a third STA and a fourth STA, and wherein the first channel comprises a channel between the first STA and the third STA and the second channel comprises a channel between the second STA and the fourth STA. In some examples, the at least one second wireless communication device comprises a second MLD (i.e. a single device) having the third STA and the fourth STA affiliated with it. However, in other examples, the first wireless communication device may communicate with different devices on the first channel and the second channel respectively. Therefore, for example, the at least one second wireless communication device may comprise at least two second wireless communication devices, wherein each of the third STA and the fourth STA is included in a different second wireless communication device. Each of the first, second, third and fourth STAs may comprise an access point STA (AP STA) or a non-access point STA (non-AP STA).

In some examples, the first wireless communication device may announce the selected supported communication parameters and/or the selected communication mode. This may be done for example in a control frame, a management frame or a data frame, and for example in a unicast, multicast or broadcast transmission. In some examples, the selected supported communication parameters may be announced periodically and/or upon a change (e.g. on a change from STR mode to NSTR mode or vice versa).

In some examples, selecting supported communication parameters in step 104 of the method 100 may be based further on the first channel and the second channel. That is, for example, the parameters may be specific to the pair of channels comprising the first channel and the second channel, and where the communication parameters may be different for a different pair of channels in some examples (where the different pair of channels may or may not include one of the first and second channels). Selecting supported communication parameters associated with a pair of channels comprising the first channel and the second channel may in some examples comprise selecting supported communication parameters specific to the pair of channels comprising the first channel and the second channel and also specific to the selected communication mode. Thus, for example, each pair of channels that may be used by the first wireless communication device may be associated with two sets of supported communication parameters, each for the STR and NSTR mode respectively. In some examples, each set may include two subsets as suggested above, where a subset is selected depending on which of the first and second channels is used for transmission and which is used for reception.

The following provides a particular example implementation of an embodiment of this disclosure.

Consider a battery-powered MLD that would normally operate as a non-AP MLD, for example a mobile phone handset. Let its default set of communication parameters include a maximum supported TX power of 20 dBm, supported RX MCSs covering MCS indexes 0-13 (modulations from BPSK to 4K-QAM), supported signal bandwidths as {20 MHz, 40 MHz, 80 MHz, 160 MHz}, and maximum number of supported spatial streams as 8.

To operate as a non-AP MLD over a STR-constrained link pair, the MLD may simply declare itself to be a NSTR non-AP MLD over that link pair with the default set of communication parameters and leave it to the associated STR AP MLD to fulfil its QoS requirements. The AP MLD would then have to ensure adherence to numerous rules and restrictions such as those described above while serving the MLD. However, if the MLD has stringent latency requirements and would like to take maximum advantage of the channel access benefits that are possible due to its ML capabilities, then it may determine an adapted set of supported communication parameters as discussed in the examples above, which would address the cross-channel SI problem, and instead declare itself and operate as a STR non-AP MLD over the same link pair. The adapted set of supported communication parameters may include, for example:
A reduced maximum TX power of 5 dBm,
A smaller set of supported RX MCSs covering MCS indexes 0-9 (modulations from BPSK to 256-QAM),
A smaller set of supported signal bandwidths {20 MHz, 40 MHz, 80 MHz}, with a lower maximum supported bandwidth, and/or
A reduced maximum number of supported spatial streams as 4.

Operating as a STR non-AP MLD would allow the MLD to independently access the two links, thereby enhancing the channel access possibilities which would in turn help to achieve better latency performance. It can be noted here that employing an adapted set of supported communication parameters may result in, for example, a reduction in achievable throughput, but the MLD may be aware of the corresponding potential tradeoff and still prefer to operate as a STR non-AP MLD due to the stringent latency requirements. A key advantage provided by embodiments of this disclosure to a wireless communication device such as a MLD would be the flexibility to decide whether to operate in STR or NSTR mode over a STR-constrained link pair, and the MLD may have various options for an appropriate selection of supported communication parameters. Some example options and potential tradeoffs for adapting the communication parameters to be able to operate as a STR MLD are provided in Table 1 below.

TABLE 1
Example Parameter Selection by a MLD for STR-Constrained Link Pair.

| Parameter Selection | | | |
|---|---|---|---|
| Options for MLD for STR- | For Operation | For Operation | Potential |
| Constrained Link Pair | as NSTR MLD | as STR MLD | Tradeoff |
| Option 1: Reduce maximum | 20 dBm | 5 dBm | Reduced |
| supported TX power | | | coverage area |
| Option 2: Limit supported | MCS0-MCS13 | MCS0-MCS9 | Reduced RX |
| RX MCSs | | | throughput |
| Option 3: Limit supported | 20 MHz, 40 MHz, | 20 MHz, 40 | Reduced |
| signal bandwidths | 80 MHz, 160 MHz | MHz, 80 MHz | throughput |
| Option 4: Reduce maximum | 8 | 4 | Reduced |
| number of supported | | | throughput |
| spatial streams | | | |

The decision made by the MLD to operate as a NSTR MLD or a STR MLD (that is, in NSTR or STR communication mode) over the STR-constrained link pair may not be very consequential while operating as a non-AP MLD in some examples, since the burden may be on the associated AP MLD to ensure efficient execution of MLOs and fulfil the non-AP MLD's QoS requirements. However, the decision would be important when the MLD itself has to operate as an AP MLD. As discussed above, the rules and restrictions for the operation of a NSTR Soft AP MLD build upon those for the operation of a NSTR non-AP MLD and have the potential to be detrimental in nature to not just the NSTR Soft AP MLD, but also to the non-AP STAs that it would serve. For example, if the MLD in this example operates as a NSTR Soft AP MLD with its default set of supported communication parameters, it would have to serve all single link non-AP STAs only over one of the two links, which would worsen the latency performance, particularly if the number of associated single-link STAs increases. Thus, the MLD may instead choose to determine an adapted set of supported communication parameters (for example, based on the options in Table 1 above) so that it would be able to operate as a STR AP MLD and use both links independently to provide its associated non-AP STAs with e.g. better channel access possibilities, reduction of contention, and reduced collisions. As a simple example, when compared to operating as a NSTR Soft AP MLD (with default set of supported communication parameters) and serving two single link non-AP STAs using only one of the links in a STR-constrained link pair, operating as a STR AP MLD (with an adapted set of supported communication parameters) and serving each single link non-AP STA using a separate link would allow the MLD to ensure low latency channel access while also avoiding any contention or collisions between the two non-AP STAs.

An additional aspect to note, and suggested above in the context of the method 100 of FIG. 1, is that the set of supported communication parameters by a MLD may not be the same for both links in a supported link pair, and therefore the cross-link SI problem over that supported link pair may also not be reciprocal. For example, if the maximum allowed TX power is different for each link in a link pair supported by a MLD (say due to regulations or hardware limitations), then the affiliated STA that transmits with a higher power may be the only one causing the link pair to be classified as NSTR due to severe cross-link SI. If such non-reciprocal behavior causes that link pair to be STR-constrained, then the MLD can intentionally determine an appropriately lower value for the maximum supported TX power for only that particular affiliated STA (and not for both STAs) and then operate as a STR MLD instead of operating as a NSTR MLD. This would then result in that the tradeoff due to the communication parameter selection, in this case coverage reduction due to reduced maximum TX power, would be limited to just that particular STA, and not for the entire MLD. Therefore, some examples, the communication parameter selection undertaken by a wireless communication device with respect to a STR-constrained link pair may be limited to just one of the corresponding affiliated channels, links or STAs, and not both. This flexibility may allow the MLD to limit the communication parameter selection to only one affiliated STA, thereby potentially keeping the resultant impact due to any underlying tradeoff to a minimum.

In some example embodiments of this disclosure, the first wireless communication device or MLD may announce the determined set of supported communication parameters, e.g. in a control frame, management frame, or data frame. For example, when a MLD uses examples of this disclosure to operate as a STR AP MLD, it may announce the determined set of supported communication parameters in a beacon frame, probe response frame or a (re-)association response frame.

The announced set of supported communication parameters by a non-AP MLD could in some examples be used by an AP MLD to adapt its OFDMA for trigger-based scheduling. As an example, the AP MLD could trigger the non-AP MLD with a more robust MCS based on the announced supported communication parameters of the non-AP MLD.

It is also possible that a MLD (e.g. a mobile phone handset) that typically operates as a NSTR non-AP MLD over a STR-constrained link pair may employ embodiments of this disclosure to change its capability from being NSTR to being STR after ML setup with another MLD (say a STR AP MLD), triggered by for example when latency performance assumes higher priority (e.g. when a user starts an online gaming app). In such a scenario, along with indicating the change in capability from being NSTR to STR over the operating link pair, in some examples the MLD may also announce the adapted set of supported communication parameters. Thus, for example, the MLD may undertake appropriate signaling after ML setup to notify its associated MLD about the adapted set of supported communication parameters when it determines to and changes its capability over an operating link pair from being NSTR to STR or vice versa.

FIG. 2 is a schematic of an example of an apparatus 200 for communicating with at least one second wireless communication device on a first channel and a second channel. The apparatus 200 comprises processing circuitry 202 (e.g., one or more processors) and a memory 204 in communication with the processing circuitry 202. The memory 204 contains instructions, such as computer program code 810, executable by the processing circuitry 202. The apparatus 200 also comprises an interface 206 in communication with the processing circuitry 202. Although the interface 206, processing circuitry 202 and memory 204 are shown connected in series, these may alternatively be interconnected in any other way, for example via a bus.

In one embodiment, the memory 204 contains instructions executable by the processing circuitry 202 such that the apparatus 200 is operable/configured to select a simultaneous transmit and receive, STR, communication mode or non-simultaneous transmit and receive, NSTR, communication mode for communicating with the at least one second wireless communication device on the first channel and the second channel, select supported communication parameters for at least one of the first channel and the second channel based on the selected mode, and communicate with the at least one second wireless communication device on the first channel and the second channel using the selected communication mode and according to the selected supported communication parameters. In some examples, the apparatus 200 is operable/configured to carry out the method 100 described above with reference to FIG. 1.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method in a first wireless communication device of communicating with at least one second wireless communication device on a first channel and a second channel, the method comprising:
selecting a simultaneous transmit and receive, STR, communication mode or non-simultaneous transmit and receive, NSTR, communication mode for communicating with the at least one second wireless communication device on the first channel and the second channel;
selecting supported communication parameters for at least one of the first channel and the second channel based on the selected mode; and
communicating with the at least one second wireless communication device on the first channel and the second channel using the selected communication mode and according to the selected supported communication parameters.

2. The method of claim 1, wherein selecting supported communication parameters for at least one of the first channel and the second channel based on the selected mode comprises selecting first supported communication parameters if the selected mode is the STR mode and selecting second supported communication parameters if the selected mode is the NSTR mode, and wherein the first supported communication parameters and the second supported communication parameters are different.

3. The method of claim 2, wherein one or more of:
the first supported communication parameters include a lower maximum transmission power for at least one of the first channel and the second channel than the second supported communication parameters;
the first supported communication parameters include a lower of maximum data rate modulation and coding scheme, MCS, for at least one of the first channel and the second channel than the second supported communication parameters;
the first supported communication parameters include a lower maximum bandwidth for at least one of the first channel and the second channel than the second supported communication parameters; and
the first supported communication parameters include a lower maximum number of spatial streams for at least one of the first channel and the second channel than the second supported communication parameters.

4. The method of claim 2, wherein the first supported communication parameters include a first subset of supported communication parameters for simultaneous transmission on the first channel and reception on the second channel by the first wireless communication device, and a second subset of supported communication parameters for simultaneous reception on the first channel and transmission on the second channel by the first wireless communication device, and wherein the first subset and the second subset are different.

5. The method of claim 1, wherein selecting the STR communication mode or the NSTR communication mode is based on one or more attributes of data to be transmitted to and received from the at least one second wireless communication device.

6. The method of claim 5, wherein the attributes of the data include one or more of a maximum latency requirement for the data, a Quality of Service, QoS, for the data, an amount of the data, and a throughput requirement for the data.

7. The method of claim 1, wherein the first wireless communication device comprises a first multi-link device, MLD.

8. The method of claim 7, wherein the first MLD has affiliated with it a first station, STA, and a second STA, and the at least one second wireless communication device comprises a third STA and a fourth STA, and wherein the first channel comprises a channel between the first STA and the third STA and the second channel comprises a channel between the second STA and the fourth STA.

9. The method of claim 8, wherein:
the at least one second wireless communication device comprises a second MLD with which the third STA and the fourth STA are affiliated; or
the at least one second wireless communication device comprises at least two second wireless communication devices, wherein each of the third STA and the fourth STA is included in a different second wireless communication device.

10. The method of claim 8, wherein:
the first STA comprises an access point, AP, STA or a non-AP STA;
the second STA comprises an AP STA or a non-AP STA;
the third STA comprises an AP STA or a non-AP STA; and
the fourth STA comprises an AP STA or a non-AP STA.

11. The method of claim 1, comprising announcing one or both of the selected supported communication parameters and the selected communication mode.

12. The method of claim 11, comprising announcing the selected supported communication parameters in a control frame, a management frame or a data frame.

13. The method of claim 1, wherein selecting supported communication parameters is further based on the first channel and the second channel.

14. The method of claim 13, wherein selecting supported communication parameters further based on the first channel and the second channel comprises selecting supported communication parameters specific to a pair of channels comprising the first channel and the second channel.

15. The method of claim 14, wherein selecting supported communication parameters associated with a pair of channels comprising the first channel and the second channel comprises selecting supported communication parameters specific to the pair of channels comprising the first channel and the second channel and also specific to the selected communication mode.

16. The method of claim 14, wherein the first communication device supports wireless communication using a plurality of pairs of channels including the pair of channels comprising the first channel and the second channel, and each pair of channels is associated with respective supported communication channels for the STR mode and respective supported communication channels for the NSTR mode.

17.-19. (canceled)

20. An apparatus for communicating with at least one second wireless communication device on a first channel and a second channel, the apparatus comprising a processor and a memory, the memory containing instructions executable by the processor such that the apparatus is operable to:
select a simultaneous transmit and receive, STR, communication mode or non-simultaneous transmit and receive, NSTR, communication mode for communicating with the at least one second wireless communication device on the first channel and the second channel;
select supported communication parameters for at least one of the first channel and the second channel based on the selected mode; and
communicate with the at least one second wireless communication device on the first channel and the second channel using the selected communication mode and according to the selected supported communication parameters.

21. The apparatus of claim 20, wherein selecting supported communication parameters for at least one of the first channel and the second channel based on the selected mode comprises selecting first supported communication parameters if the selected mode is the STR mode and selecting second supported communication parameters if the selected mode is the NSTR mode, and wherein the first supported communication parameters and the second supported communication parameters are different.

22. (canceled)

23. (canceled)

24. The apparatus of claim 21, wherein one or more of:
the first supported communication parameters include a lower maximum transmission power for at least one of the first channel and the second channel than the second supported communication parameters;
the first supported communication parameters include a lower of maximum data rate modulation and coding scheme, MCS, for at least one of the first channel and the second channel than the second supported communication parameters;
the first supported communication parameters include a lower maximum bandwidth for at least one of the first channel and the second channel than the second supported communication parameters; and
the first supported communication parameters include a lower maximum number of spatial streams for at least one of the first channel and the second channel than the second supported communication parameters.
